(19) United States
(12) Patent Application Publication
(10) Pub. No.: US 2018/0191769 A1
(43) Pub. Date: Jul. 5, 2018

(54) AUGMENTED REALITY MONITOR

(71) Applicant: Glen J. Anderson, Beaverton, OR (US)

(72) Inventor: Glen J. Anderson, Beaverton, OR (US)

(21) Appl. No.: 15/395,701

(22) Filed: Dec. 30, 2016

(51) Int. Cl. H04L 29/06; G08B 21/02; G06F 1/16

(52) U.S. Cl. CPC H04L 63/1441; G08B 21/02; H04L 63/1433; H04L 63/101; G06F 1/163

(57) ABSTRACT

Systems, apparatuses and methods may provide for technology that identifies augmented reality (AR) content associated with an AR delivery system and detects a hazard condition presented by the AR content to a wearer of the AR delivery system. Additionally, the hazard condition may be eliminated via the AR delivery system. In one example, the hazard condition is detected in a trusted execution environment (TEE).

### TECHNICAL FIELD

Embodiments generally relate to data security. More particularly, embodiments relate to an augmented reality monitor that enhances data security and eliminates unsafe conditions.

### BACKGROUND

Augmented reality (AR) may provide users with the ability to experience a blend of the physical environment with computer-generated content. As AR becomes more common, pranksters and individuals with darker motivations may hack into AR systems to present users with false AR information. This activity could be fairly harmless pranks, such as presenting unwanted AR characters (e.g., via visual, audible and/or haptic feedback), or more dangerous, such as visibly blocking tripping hazards or playing sirens. The risks presented by false AR information may be particularly severe for head mounted display (HMD) systems in which the user is more dependent on the display surface for reality.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of augmented reality (AR) content that presents a hazard condition to a wearer according to an embodiment;

FIG. 2 is a flowchart of a method of operating a security apparatus according to an embodiment;

FIG. 3A is a flowchart of a method of conducting physical hazard evaluations according to an embodiment;

FIG. 3B is a flowchart of a method of detecting context-sensitive risks according to an embodiment;

FIG. 4 is a block diagram of an example of a head mounted display (HMD) system according to an embodiment;

FIG. 5 is a block diagram of an example of a processor according to an embodiment; and

FIG. 6 is a block diagram of an example of a computing system according to an embodiment.

### DESCRIPTION OF EMBODIMENTS

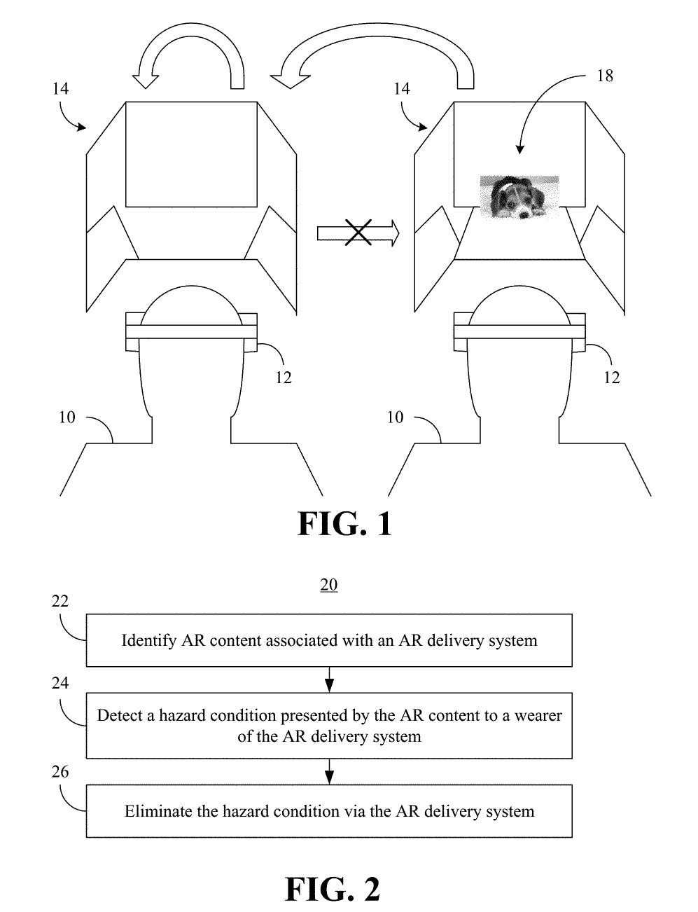

Turning now to FIG. 1, a scenario is shown in which a wearer 10 (e.g., user) of an augmented reality (AR) delivery system 12 (e.g., including a housing with a wearable form factor) views a video 14 of a physical environment that is presented on a display of the AR delivery system 12. Although the illustrated AR delivery system 12 is a head mounted display (HMD) system, other form factors such as, for example, audio only AR delivery systems (e.g., earphones), contact lens based displays, etc., may also be used. In the illustrated example, the physical environment video 14 includes a potentially dangerous area such as, for example, a stairwell 16 leading downward (e.g., into a subway station). In one or more frames of the video 14, an attempt may be made (e.g., via a hacker, malware, poorly designed content renderer, etc.) to overlay augmented reality (AR) content 18 on the video 14 in a manner that presents a hazard condition to the wearer 10. Thus, the stairwell 16 might be covered with an animated sidewalk as well as a puppy that may lure the wearer 10 to the stairwell 16. Other confusing content such as, for example, sirens, police officers, etc., may be introduced into the physical environment video 14.

As will be discussed in greater detail, the AR delivery system 12 may be equipped with security technology to automatically detect the hazard condition presented by the AR content 18. The enhanced security technology may also automatically eliminate the hazard condition via the AR delivery system 12 by, for example, preventing the AR content 18 from being overlaid on the physical environment video 14, removing the AR content 18 from the physical environment video 14, warning the wearer 10 of the risk presented by the AR content 18 and/or flagging (e.g., blacklisting) the source of the AR content 18. Accordingly, the wearer 10 may be protected from physical harm, which may in turn improve the AR experience.

FIG. 2 shows a method 20 of operating a security apparatus. The method 20 may generally be implemented in an AR delivery system such as, for example, the AR delivery system 12 (FIG. 1), already discussed. More particularly, the method 20 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 20 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 22 may identify AR content associated with an HMD system, wherein the AR content may be visual, audible, haptic and/or chemical in nature. In the case of visual AR content, block 22 may include optically detecting (e.g., via a camera or light sensor) the AR content on a display of the AR delivery system. For audible AR content, block 22 might include using a microphone to capture sound. In the case of haptic AR content, block 22 may include using a MEMS (microelectromechanical system), piezoelectric sensor or other motion sensor (e.g., accelerometer, gyroscope) to measure movements of the wearer and/or the AR delivery system. Block 22 may also include performing object recognition on the AR content in order to classify and/or quantify various attributes of the AR content (e.g., sidewalk, puppy).

Block 24 may detect a hazard condition presented by the AR content to a wearer of the AR delivery system. In one example, the hazard condition is detected in a trusted execution environment (TEE, e.g., secure hardware) in order to prevent tampering with the detection decision and/or analysis. As will be discussed in greater detail, block 24 may include identifying (e.g., via machine vision) one or more environmental hazards in a physical environment video and comparing the AR content to the environmental hazard(s). Thus, block 24 might determine the position of the AR content relative to a potentially dangerous area such as, for example, a stairwell. Block 24 may also search for the AR content in a “risky” content database (e.g., a database of items that are known to pose a potential risk to the wearer). Thus, the risky content database might contain items such as, for example, police, sirens, crosswalk signs, and so forth. In yet another example, block 24 may include comparing a source of the AR content to an application blacklist. In this regard, malware and/or other untrusted executable code may be detected and logged in the application blacklist over time.

Moreover, block 24 may determine a contextual risk level associated with the wearer of the AR delivery system, wherein the hazard condition is detected with respect to the contextual risk level. For example, it might be determined that the wearer is currently near a traffic intersection, wherein a user profile established for the wearer indicates a low risk tolerance during such a situation. Accordingly, the AR content may be determined to present a hazard condition in that case. Alternatively, the same AR content might be detected while the wearer is alone at home, wherein the user profile indicates a relatively high risk tolerance when at home. In such a case, the AR content may not result in a hazard condition being detected. Table I below shows an example of a set of user profile based rules to determine whether a hazard condition exists.

TABLE I

| Hazard or Risky Content | Context | Determination |
|---|---|---|
| Tripping hazard obstructed | User seated | No hazard condition |
| Siren | User driving | Hazard condition |
| Tripping hazard obstructed | User approaching | Hazard condition |
| Haptic vibration | User sleeping | Hazard condition |
| Smell emission | User cooking | Hazard condition |

Thus, rules may enable the AR delivery system to become more or less aggressive depending on the user's location, activity, proximity to people, proximity to moving vehicles, other hazards, and so forth. The rules shown in Table I are to facilitate discussion only and may vary depending on the circumstances. Illustrated block 26 eliminates the hazard condition via the AR delivery system. Block 26 may therefore include deactivating an AR content renderer or otherwise preventing visual, audible, haptic and/or olfactory AR content from reaching the wearer of the AR delivery system. The AR content may be either prevented from ever reaching the wearer and/or discontinued (e.g., removed from subsequent frames of the physical environment video, routed away from speakers of the AR delivery system, etc.). Block 26 may also provide for notifying the wearer of the hazard condition and/or adding a source of the AR content to an application blacklist.

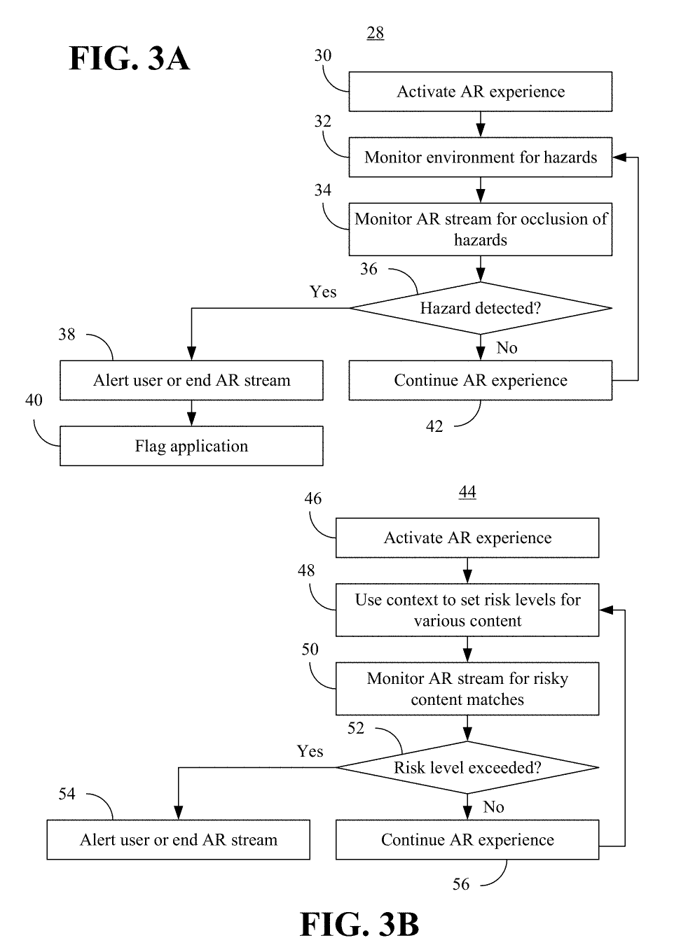

FIG. 3A shows a more detailed example of a method 28 of conducting physical hazard evaluations. The method 28 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated block 30 provides for activating an AR experience (e.g., in response to a user request), wherein the physical environment may be monitored at block 32 for potential hazards. Block 34 may monitor an AR stream for occlusion of the potential hazards. Additionally, a determination may be made at block 36 as to whether a hazard condition has been detected (e.g., AR stream is occluding the potential hazard). If so, illustrated block 38 alerts the wearer/user or ends the AR stream. The alert may take the form of a haptic vibration, a warning message presented on the display of the AR delivery system, a modification of the AR content to distinguish it from the real environment (e.g., flashing/blinking the AR content), or any other suitable technique to warn the user. The application (e.g., source) that generated the AR stream may also be flagged (e.g., blacklisted) at block 40. If no hazard condition is detected at block 36, block 42 may continue the AR experience.

FIG. 3B shows a more detailed example of a method 44 of detecting context-sensitive risks. The method 44 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

Illustrated processing block 46 activates an AR experience (e.g., in response to a user request), wherein context is used at block 48 to set risk levels for various content. Additionally, block 50 may monitor the AR stream for risky content matches. Block 50 may therefore include searching a risky content database for content identified in the AR stream. Illustrated block 52 determines whether the AR content exceeds the current risk level. If so, block 54 alerts the user or ends the AR stream. If it is determined at block 52 that the AR content does not exceed the current risk level, block 56 may continue the AR experience.

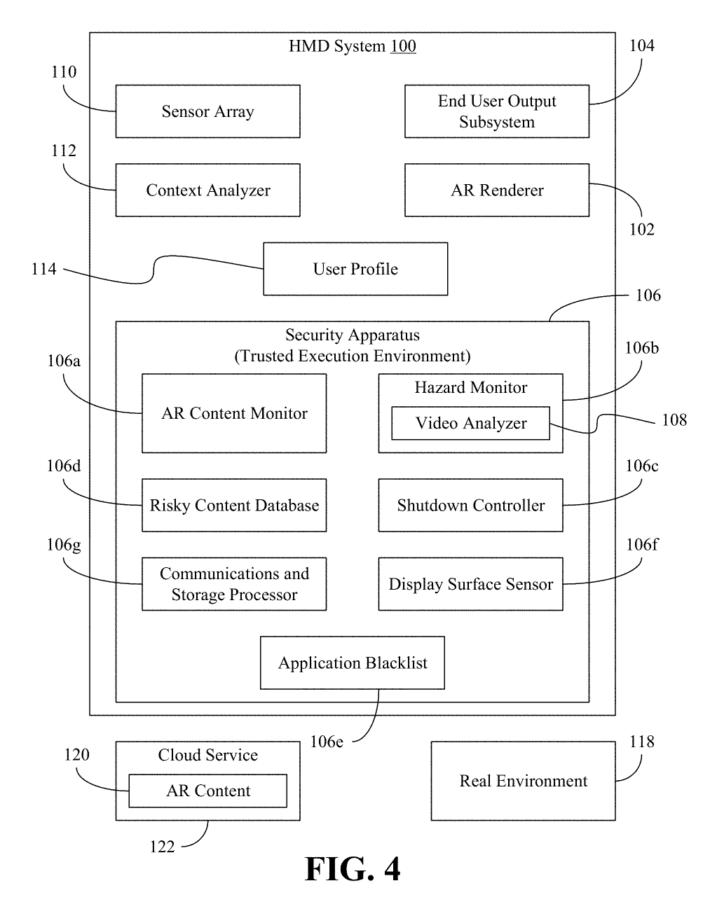

FIG. 4 shows an HMD system 100 that provides enhanced security and physical protection to the wearer of the HMD system 100. The components of the HMD system 100 may be communicatively coupled to one another via buses, communication fabrics, control registers, etc. (not shown), depending on the circumstances. In the illustrated example, an AR renderer 102 renders/generates AR content 120 and an end user output subsystem 104 (e.g., wearable display for both virtual reality/VR and AR, audio speakers, haptic vibrators, chemical atomizers) is communicatively coupled to the AR renderer 102. The output system 104 may present audio and video of a real environment 118, with the AR content 120 being overlaid on one or more frames of the video. The AR renderer 102 may obtain the AR content 120 from a cloud service 122 or generate the AR content 120 internally. A security apparatus 106 (106a-106g), which may include logic instructions, configurable logic, fixed-functionality logic hardware, etc., or any combination thereof, may generally implement one or more aspects of the method 20 (FIG. 2), the method 28 (FIG. 3A) and/or the method 44 (FIG. 3B).

More particularly, the security apparatus 106 may include an AR content monitor 106a to identify the AR content generated by the AR renderer 102. Additionally, a hazard monitor 106b communicatively coupled to the AR content monitor 106a may detect hazard conditions presented by the AR content to the wearer of the HMD system 100. The hazard monitor 106b might use, for example, machine vision to recognize drops in elevation (e.g., stairs), intersections with moving vehicles, AR sounds that mask background sounds in the real environment 118, and so forth. The illustrated security apparatus 106 also includes a shutdown controller 106c communicatively coupled to the hazard monitor 106b, wherein the shutdown controller 106c eliminates the hazard condition via the HMD system 100. For example, the shutdown controller 106c might prevent the AR content 120 from being conveyed to the wearer via the output subsystem 104.

In one example, the security apparatus 106 is a trusted execution environment (TEE) that includes secure hardware. Accordingly, the likelihood of unauthorized tampering with the AR content monitor 106a, the hazard monitor 106b and/or the shutdown controller 106c may be minimal and/or negligible. In one example, the hazard monitor 106b includes a video analyzer 108 to identify one or more environmental hazards in the video of the real environment 118 and compare the AR content 120 to the environmental hazard(s) to detect the hazard conditions. In such a case, the shutdown controller 106c might prevent the AR content from being overlaid or otherwise incorporated into one or more frames of the physical environment video. Indeed, the shutdown controller 106c may cause the AR content to flash/blink off and on in order to distinguish the dangerous AR content from the real environment 118.

The security apparatus 106 may also include a risky content database 106d, wherein the hazard monitor 106b searches for the AR content 120 in the risky content database 106d to detect the hazard conditions. The illustrated security apparatus 106 further includes an application blacklist 106e. Accordingly, the hazard monitor 106b might compare the cloud service 122 (e.g., the AR content source) to the application blacklist 106e to detect the hazard conditions. Moreover, the hazard monitor 106b may update the application blacklist 106e with data collected about untrusted applications over time.

The HMD system 100 may also include a sensor array 110 (e.g., depth cameras, microphones, vibration sensors, tactile sensors, conductance sensors, proximity sensors, location sensors, simultaneous localization and mapping/SLAM sensors, Global Positioning System/GPS receivers, etc.) to facilitate the determination of contextual risk levels by a context analyzer 112. The context analyzer 112 may also take into consideration information in a user profile 114 that is specific to the wearer of the HMD system 100 (e.g., wearer's age). The sensor array 110, the user profile 114 and/or the context analyzer 112 may have a trusted (e.g., dedicated) communication path to the security apparatus 106 to prevent manipulation and/or spoofing of context data. Indeed, the context analyzer 112 and/or the user profile 114 may alternatively be positioned within the TEE of the security apparatus 106.

The illustrated security apparatus 106 also includes a display surface sensor 106f (e.g., camera, light sensor) to optically detect the AR content 120 on a display in the output subsystem 104. Thus, the display surface sensor 106f may be directed towards the display and configured to determine X-Y-Z coordinates of the AR content 120 relative to each frame of the video presented on the display. The display surface sensor 106f may also include an eye tracker to determine the region of interest in each frame of the video. The security apparatus 106 also includes a communications and storage processor 106g to transfer and manage data involved in the monitoring of the AR content 120.

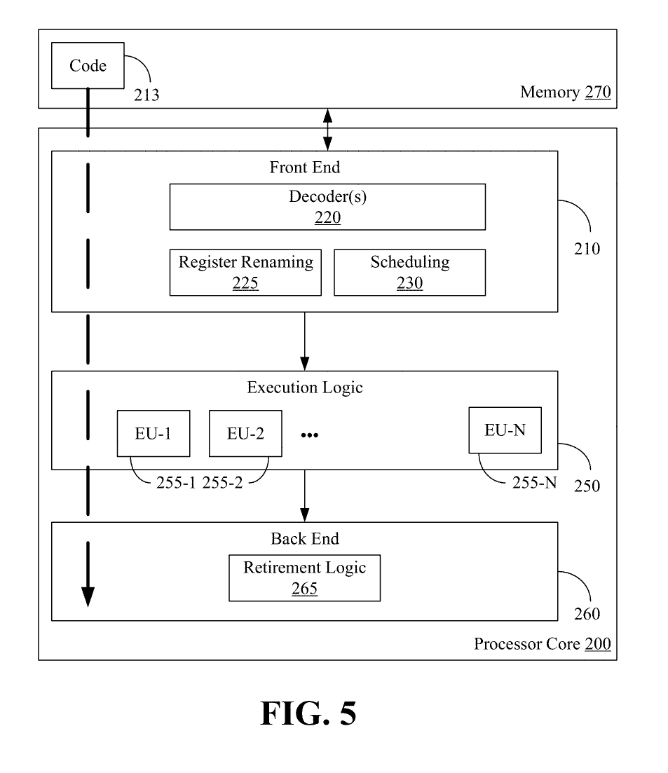

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 20 (FIG. 2), the method 28 (FIG. 3A) and/or the method 44 (FIG. 3B), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

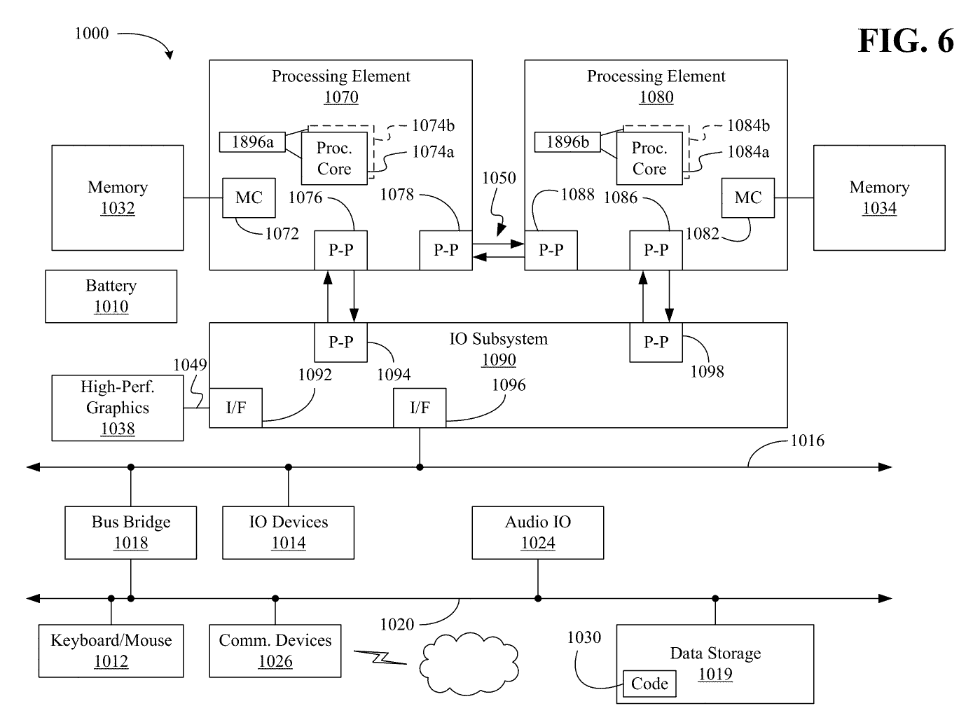

Referring now to FIG. 6, shown is a block diagram of a computing system 1000 embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 5.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 20 (FIG. 2), the method 28 (FIG. 3A) and/or the method 44 (FIG. 3B), already discussed, and may be similar to the code 213 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Example 1 may include an augmented reality (AR) delivery system comprising a housing including a wearable form factor, an augmented reality (AR) renderer to generate AR content, an output subsystem communicatively coupled to the AR renderer, and a security apparatus including an AR content monitor to identify the AR content, a hazard monitor communicatively coupled to the AR content monitor, the hazard monitor to detect a hazard condition presented by the AR content to a wearer of the HMD system, and a shutdown controller communicatively coupled to the hazard monitor, the shutdown controller to eliminate the hazard condition via the output subsystem.

Example 2 may include the system of Example 1, wherein the security apparatus further includes a trusted execution environment, and wherein the hazard monitor is positioned within the trusted execution environment.

Example 3 may include the system of Example 1, wherein the hazard monitor includes a video analyzer to identify one or more environmental hazards in a physical environment video and compare the AR content to the one or more environmental hazards to detect the hazard condition, and wherein the shutdown controller is to prevent the AR content from being overlaid on one or more frames of the physical environment video to eliminate the hazard condition.

Example 4 may include the system of Example 1, wherein the security apparatus further includes a risky content database, and wherein the hazard monitor is to search for the AR content in the risky content database to detect the hazard condition.

Example 5 may include the system of any one of Examples 1 to 4, wherein the security apparatus further includes an application blacklist, wherein the hazard monitor is to compare a source of the AR content to an application blacklist to detect the hazard condition.

Example 6 may include a security apparatus comprising an augmented reality (AR) content monitor to identify AR content associated with an AR delivery system, a hazard monitor communicatively coupled to the AR content monitor, the hazard monitor to detect a hazard condition presented by the AR content to a wearer of the AR delivery system, and a shutdown controller communicatively coupled to the hazard monitor, the shutdown controller to eliminate the hazard condition via the AR delivery system.

Example 7 may include the apparatus of Example 6, further including a trusted execution environment, wherein the hazard monitor is positioned within the trusted execution environment.

Example 8 may include the apparatus of Example 6, wherein the hazard monitor includes a video analyzer to identify one or more environmental hazards in a physical environment video and compare the AR content to the one or more environmental hazards to detect the hazard condition, and wherein the shutdown controller is to prevent the AR content from being overlaid on one or more frames of the physical environment video to eliminate the hazard condition.

Example 9 may include the apparatus of Example 6, further including a risky content database, wherein the hazard monitor is to search for the AR content in the risky content database to detect the hazard condition.

Example 10 may include the apparatus of any one of Examples 6 to 9, further including an application blacklist, wherein the hazard monitor is to compare a source of the AR content to an application blacklist to detect the hazard condition.

Example 11 may include the apparatus of any one of Examples 6 to 9, further including a display surface sensor to optically detect the AR content on a display of the AR delivery system.

Example 12 may include the apparatus of any one of Examples 6 to 9, further including a context analyzer to determine a contextual risk level associated with the wearer of the AR delivery system, wherein the hazard condition is to be detected with respect to the contextual risk level.

Example 13 may include a method of operating a security apparatus, comprising identifying augmented reality (AR) content associated with an AR delivery system, detecting a hazard condition presented by the AR content to a wearer of the AR delivery system, and eliminating the hazard condition via the AR delivery system.

Example 14 may include the method of Example 13, wherein the hazard condition is detected in a trusted execution environment.

Example 15 may include the method of Example 13, wherein detecting the hazard condition includes identifying one or more environmental hazards in a physical environment video, and comparing the AR content to the one or more environmental hazards, wherein eliminating the hazard condition includes preventing the AR content from being overlaid on one or more frames of the physical environment video.

Example 16 may include the method of Example 13, wherein detecting the hazard condition includes searching for the AR content in a risky content database.

Example 17 may include the method of any one of Examples 13 to 16, wherein detecting the hazard condition includes comparing a source of the AR content to an application blacklist to detect the hazard condition.

Example 18 may include at least one computer readable storage medium comprising a set of instructions, which when executed by a computing device, cause the computing device to identify augmented reality (AR) content associated with an AR delivery system, detect a hazard condition presented by the AR content to a wearer of the AR delivery system, and eliminate the hazard condition via the AR delivery system.

Example 19 may include the at least one computer readable storage medium of Example 18, wherein the hazard condition is to be detected in a trusted execution environment.

Example 20 may include the at least one computer readable storage medium of Example 18, wherein the instructions, when executed, cause the computing device to identify one or more environmental hazards in a physical environment video, and compare the AR content to the one or more environmental hazards to detect the hazard condition, and prevent the AR content from being overlaid on one or more frames of the physical environment video to eliminate the hazard condition.

Example 21 may include the at least one computer readable storage medium of Example 18, wherein the instructions, when executed, cause the computing device to search for the AR content in a risky content database to detect the hazard condition.

Example 22 may include the at least one computer readable storage medium of any one of Examples 18 to 21, wherein the instructions, when executed, cause the computing device to compare a source of the AR content to an application blacklist to detect the hazard condition.

Example 23 may include the at least one computer readable storage medium of any one of Examples 18 to 21, wherein the instructions, when executed, cause the computing device to optically detect the AR content on a display of the AR delivery system.

Example 24 may include the at least one computer readable storage medium of any one of Examples 18 to 21, wherein the instructions, when executed, cause the computing device to determine a contextual risk level associated with the wearer of the AR delivery system, wherein the hazard condition is to be detected with respect to the contextual risk level.

Example 25 may include a security apparatus comprising means for identifying augmented reality (AR) content associated with AR delivery system, means for detecting a hazard condition presented by the AR content to a wearer of the AR delivery system, and means for eliminating the hazard condition via the AR delivery system.

Example 26 may include the apparatus of Example 25, wherein the hazard condition is to be detected in a trusted execution environment.

Example 27 may include the apparatus of Example 25, wherein detecting the hazard condition includes means for identifying one or more environmental hazards in a physical environment video, and means for comparing the AR content to the one or more environmental hazards, wherein the means for eliminating the hazard condition includes means for preventing the AR content from being overlaid on one or more frames of the physical environment video.

Example 28 may include the apparatus of Example 25, wherein the means for detecting the hazard condition includes means for searching for the AR content in a risky content database.

Example 29 may include the apparatus of any one of Examples 25 to 28, wherein the means for detecting the hazard condition includes means for comparing a source of the AR content to an application blacklist to detect the hazard condition.

Thus, technology described herein may actively evaluate AR content against the physical environment to protect the user from possibly hacked content, poorly designed AR content, or simple distractions from AR content.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An augmented reality (AR) delivery system comprising:
a housing including a wearable form factor;
an augmented reality (AR) renderer to generate AR content;
an output subsystem communicatively coupled to the AR renderer; and
a security apparatus including:
an AR content monitor to identify the AR content;
a hazard monitor communicatively coupled to the AR content monitor, the hazard monitor to detect a hazard condition presented by the AR content to a wearer of a head mounted display (HMD) system; and
a shutdown controller communicatively coupled to the hazard monitor, the shutdown controller to eliminate the hazard condition via the output subsystem,
wherein the security apparatus further includes a risky content database, and wherein the hazard monitor is to search for the AR content in the risky content database to detect the hazard condition.

2. The system of claim 1, wherein the security apparatus further includes a trusted execution environment, and wherein the hazard monitor is positioned within the trusted execution environment.

3. The system of claim 1, wherein the hazard monitor includes a video analyzer to identify one or more environmental hazards in a physical environment video and compare the AR content to the one or more environmental hazards to detect the hazard condition, and wherein the shutdown controller is to prevent the AR content from being overlaid on one or more frames of the physical environment video to eliminate the hazard condition.

4. (canceled)

5. The system of claim 1, wherein the security apparatus further includes an application blacklist, wherein the hazard monitor is to compare a source of the AR content to an application blacklist to detect the hazard condition.

6. An apparatus comprising:
an augmented reality (AR) content monitor to identify AR content associated with an AR delivery system;
a hazard monitor communicatively coupled to the AR content monitor, the hazard monitor to detect a hazard condition presented by the AR content to a wearer of a head mounted display (HMD) system; and
a shutdown controller communicatively coupled to the hazard monitor, the shutdown controller to eliminate the hazard condition via the HMD system,
wherein the hazard monitor is to search for the AR content in the risky content database to detect the hazard condition.

7. The apparatus of claim 6, further including a trusted execution environment, wherein the hazard monitor is positioned within the trusted execution environment.

8. The apparatus of claim 6, wherein the hazard monitor includes a video analyzer to identify one or more environmental hazards in a physical environment video and compare the AR content to the one or more environmental hazards to detect the hazard condition, and wherein the shutdown controller is to prevent the AR content from being overlaid on one or more frames of the physical environment video to eliminate the hazard condition.

9. (canceled)

10. The apparatus of claim 6, further including an application blacklist, wherein the hazard monitor is to compare a source of the AR content to an application blacklist to detect the hazard condition.

11. The apparatus of claim 6, further including a display surface sensor to optically detect the AR content on a display of the HMD system.

12. The apparatus of claim 6, further including a context analyzer to determine a contextual risk level associated with the wearer of the HMD system, wherein the hazard condition is to be detected with respect to the contextual risk level.

13. A method of operating an augmented reality (AR) delivery system comprising:
identifying AR content associated with the AR delivery system, the identifying to be performed by an AR content monitor of the AR delivery system;
detecting a hazard condition presented by the AR content to a wearer of a head mounted display (HMD) system, the detecting to be performed by a hazard monitor of the AR delivery system; and
eliminating the hazard condition via the HMD system, the eliminating to be performed by a shutdown controller of the AR delivery system,
wherein detecting the hazard condition includes searching for the AR content in a risky content database.

14. The method of claim 13, wherein the hazard condition is detected in a trusted execution environment.

15. The method of claim 13, wherein detecting the hazard condition includes:
identifying one or more environmental hazards in a physical environment video; and
comparing the AR content to the one or more environmental hazards, wherein eliminating the hazard condition includes preventing the AR content from being overlaid on one or more frames of the physical environment video.

16. (canceled)

17. The method of claim 13, wherein detecting the hazard condition includes comparing a source of the AR content to an application blacklist to detect the hazard condition.

18. At least one non-transitory computer readable storage medium comprising a set of instructions, which when executed by a computing device, cause the computing device to:
identify augmented reality (AR) content associated with an AR delivery system, the identifying to be performed by an AR content monitor of the AR delivery system;
detect a hazard condition presented by the AR content to a wearer of a head mounted display (HMD) system, the detecting to be performed by a hazard monitor of the AR delivery system; and
eliminate the hazard condition via the HMD system, the eliminating to be performed by a shutdown controller of the AR delivery system,
wherein the instructions, when executed, cause the computing device to search for the AR content in a risky content database to detect the hazard condition.

19. The at least one non-transitory computer readable storage medium of claim 18, wherein the hazard condition is to be detected in a trusted execution environment.

20. The at least one non-transitory computer readable storage medium of claim 18, wherein the instructions, when executed, cause the computing device to:
identify one or more environmental hazards in a physical environment video; and
compare the AR content to the one or more environmental hazards to detect the hazard condition; and
prevent the AR content from being overlaid on one or more frames of the physical environment video to eliminate the hazard condition.

21. (canceled)

22. The at least one non-transitory computer readable storage medium of claim 18, wherein the instructions, when executed, cause the computing device to compare a source of the AR content to an application blacklist to detect the hazard condition.

23. The at least one non-transitory computer readable storage medium of claim 18, wherein the instructions, when executed, cause the computing device to optically detect the AR content on a display of the HMD system.

24. The at least one non-transitory computer readable storage medium of claim 18, wherein the instructions, when executed, cause the computing device to determine a contextual risk level associated with the wearer of the HMD system, wherein the hazard condition is to be detected with respect to the contextual risk level.
